(19) United States
(12) Patent Application Publication
(10) Pub. No.: US 2021/0135177 A1
(43) Pub. Date: May 6, 2021

(54) ENERGY ABSORBING STRUCTURES FOR TRACTION BATTERY PACKS

(71) Applicant: FORD GLOBAL TECHNOLOGIES, LLC, Dearborn, MI (US)

(72) Inventors: Anil KALRA, Canton, MI (US); Rahul ARORA, Birmingham, MI (US)

(21) Appl. No.: 16/674,498

(22) Filed: Nov. 5, 2019

(51) Int. Cl. H01M 2/10; B60K 1/04

(52) U.S. Cl. CPC H01M 2/1094; H01M 2/1077; H01M 2220/20; B60K 1/04; H01M 2/1083

(57) ABSTRACT

This disclosure is directed toward traction battery packs that include energy absorbing structures for protecting the internal contents of the battery pack. An exemplary battery pack may include an enclosure assembly and one or more battery arrays that are housed within the enclosure assembly. The enclosure assembly includes an energy absorbing structure that may include a plurality of fluid filled unit cells. The stiffness of each fluid filled unit cell may be controlled by allowing fluid to be released from the unit cells during vehicle impact events, thereby absorbing impact energy that could otherwise be imparted inside the battery pack.

### TECHNICAL FIELD

This disclosure relates generally to traction battery packs, and more particularly to energy absorbing structures for protecting the traction battery packs during impact loading events.

### BACKGROUND

The desire to reduce automotive fuel consumption and emissions has been well documented. Therefore, electrified vehicles are being developed that reduce or completely eliminate reliance on internal combustion engines. In general, electrified vehicles differ from conventional motor vehicles because they are selectively driven by one or more battery powered electric machines. Conventional motor vehicles, by contrast, rely exclusively on the internal combustion engine to propel the vehicle.

A high voltage traction battery pack typically powers the electric machines and other electrical loads of the electrified vehicle. The battery pack may be susceptible to various vehicle loads, including loads that are imparted during vehicle impact loading events (e.g., front, side, side pole, rear, etc.) during operation of the electrified vehicle.

### SUMMARY

battery pack according to an exemplary aspect of the present disclosure includes, among other things, an enclosure assembly and a battery array received within the enclosure assembly. The enclosure assembly includes an energy absorbing structure comprised of a plurality of fluid filled unit cells.

In a further non-limiting embodiment of the foregoing battery pack, each of the plurality of fluid filled unit cells is made of a compressible polymer-based or metallic material.

In a further non-limiting embodiment of either of the foregoing battery packs, each of the plurality of fluid filled unit cells includes an outer housing that includes a hollow chamber, and a fluid is held within the hollow chamber.

In a further non-limiting embodiment of any of the foregoing battery packs, the fluid is a compressed air or a coolant.

In a further non-limiting embodiment of any of the foregoing battery packs, a vent hole is formed in the outer housing, and a membrane covers the vent hole.

In a further non-limiting embodiment of any of the foregoing battery packs, the membrane is configured to rupture as a pressure inside the outer housing increases.

In a further non-limiting embodiment of any of the foregoing battery packs, at least one of the plurality of fluid filled unit cells include an hourglass shape.

In a further non-limiting embodiment of any of the foregoing battery packs, the plurality of fluid filled unit cells are attached to a rigid plate of a wall of the enclosure assembly.

In a further non-limiting embodiment of any of the foregoing battery packs, the plurality of fluid filled unit cells are sandwiched between a first rigid plate and a second rigid plate of a wall of the enclosure assembly.

In a further non-limiting embodiment of any of the foregoing battery packs, the plurality of fluid filled unit cells are arranged in an array of horizontal and vertical rows within a wall of the enclosure assembly.

In a further non-limiting embodiment of any of the foregoing battery packs, each of the plurality of fluid filled unit cells includes an outer housing, a hollow chamber that contains a fluid inside the outer housing, a vent hole formed through the outer housing, and a membrane that covers the vent hole.

In a further non-limiting embodiment of any of the foregoing battery packs, the membrane is configured to rupture as a pressure inside the outer housing increases, thereby allowing the fluid to escape through the vent hole to a location outside of the outer housing.

An electrified vehicle according to another exemplary aspect of the present disclosure includes, among other things, a frame and a traction battery pack mounted to the frame. The traction battery pack includes an energy absorbing structure that comprises a plurality of fluid filled unit cells.

In a further non-limiting embodiment of the foregoing electrified vehicle, the frame includes a first rail and a second rail that establish part of an underbody of the electrified vehicle. The traction battery pack is mounted between the first rail and the second rail.

In a further non-limiting embodiment of either of the foregoing electrified vehicles, each of the plurality of fluid filled unit cells includes an outer housing, a hollow chamber within the outer housing, and a fluid contained within the hollow chamber.

In a further non-limiting embodiment of any of the foregoing electrified vehicles, a vent hole is formed through the outer housing and a membrane covers the vent hole to contain the fluid within the hollow chamber during a non-loaded condition of the energy absorbing structure.

In a further non-limiting embodiment of any of the foregoing electrified vehicles, during a loaded condition of the energy absorbing structure, the membrane is configured to rupture and allow the fluid to leak out of the outer housing through the vent hole.

In a further non-limiting embodiment of any of the foregoing electrified vehicles, the fluid is a coolant.

In a further non-limiting embodiment of any of the foregoing electrified vehicles, the outer housing comprises a first material and the membrane comprises a second material that is different from the first material.

In a further non-limiting embodiment of any of the foregoing electrified vehicles, the second material is a nylon fabric.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates an underside of the electrified vehicle of FIG. 1.

FIG. 3 illustrates an exemplary battery pack of an electrified vehicle.

FIG. 4 is a cross-sectional view through section 4-4 of the battery pack of FIG. 3.

FIG. 5 illustrates an energy absorbing structure of an enclosure assembly of the battery pack of FIGS. 3-4.

FIG. 6 is a blown-up view of a portion of the energy absorbing structure of FIG. 5.

FIG. 7 illustrates another exemplary energy absorbing structure of a battery pack enclosure assembly.

FIG. 8 is a front view of a fluid filled unit cell of an energy absorbing structure.

FIG. 9 is an isometric view of the fluid filled unit cell of FIG. 8.

FIG. 10 is a top view of the fluid filled unit cell of FIG. 8.

FIG. 11 illustrates another exemplary fluid filled unit cell of an energy absorbing structure.

FIG. 12 illustrates another exemplary fluid filled unit cell of an energy absorbing structure.

FIG. 13 illustrates yet another exemplary fluid filled unit cell of an energy absorbing structure.

FIG. 14 schematically illustrates a non-loaded condition of a fluid filled unit cell of an energy absorbing structure.

FIG. 15 schematically illustrates a loaded condition of a fluid filled unit cell of an energy absorbing structure.

### DETAILED DESCRIPTION

This disclosure is directed to traction battery packs that include energy absorbing structures for protecting the internal contents of the battery pack. An exemplary battery pack may include an enclosure assembly and one or more battery arrays that are housed within the enclosure assembly. The enclosure assembly includes an energy absorbing structure that may include a plurality of fluid filled unit cells. The stiffness of each fluid filled unit cell may be controlled by regulating a pressure inside the fluid filled unit cells. For example, the stiffness can be controlled by allowing fluid to be released from the unit cells during vehicle impact events, thereby absorbing impact energy that could otherwise be imparted inside the battery pack. These and other features are discussed in greater detail in the following paragraphs of this detailed description.

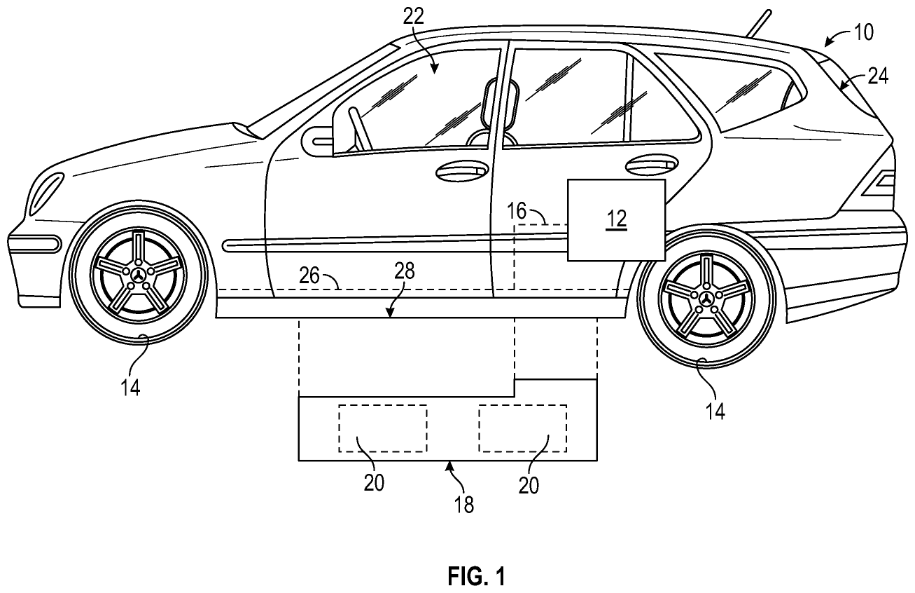

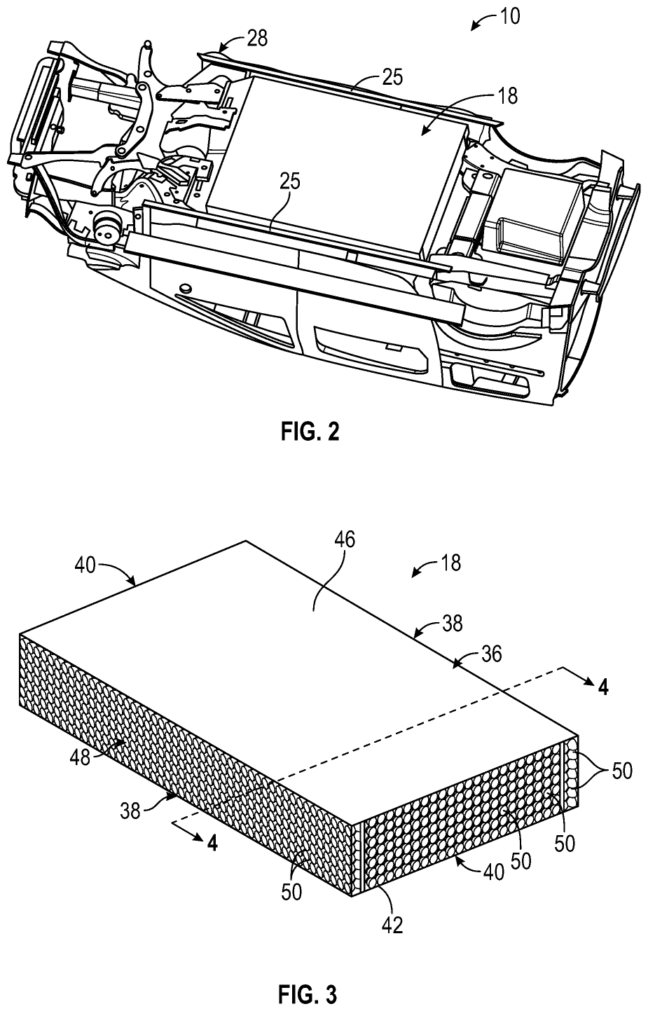

FIGS. 1 and 2 schematically illustrate an electrified vehicle 10. The electrified vehicle 10 could be a car, a truck, a van, a sport utility vehicle, a crossover, or any other type of vehicle that includes an electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEVs), fuel cell vehicles, etc. Therefore, although not specifically shown in this embodiment, the electrified vehicle 10 could be equipped with an internal combustion engine that can be employed either alone or in combination with other energy sources to propel the electrified vehicle 10.

Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component.

In the illustrated embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and provides a rotational output torque to one or more drive wheels 14 of the electrified vehicle 10.

A voltage bus 16 electrically connects the electric machine 12 to a battery pack 18. The battery pack 18 is an exemplary electrified vehicle traction battery. The battery pack 18 may be a high voltage traction battery pack that includes a plurality of battery arrays 20 (i.e., battery assemblies or groupings of rechargeable battery cells) capable of outputting electrical power to operate the electric machine 12 and/or other electrical loads of the electrified vehicle 10. Other types of energy storage devices and/or output devices can also be used to electrically power the electrified vehicle 10.

The battery pack 18 may be mounted at various locations of the electrified vehicle 10. In an embodiment, the electrified vehicle 10 includes a passenger cabin 22 and a cargo space 24 (e.g., a trunk) located to the rear of the passenger cabin 22. A floor pan 26 may separate the passenger cabin 22 from a vehicle frame 28, which generally establishes the vehicle underbody. The battery pack 18 may be suspended from or otherwise mounted to the vehicle frame 28 such that it is remote from both the passenger cabin 22 and the cargo space 24. The battery pack 18 therefore does not occupy space that would otherwise be available for carrying passengers or cargo.

The vehicle frame 28 may include a pair side rails 25 (sometimes referred to as “frame rails” or “beams”) that are spaced apart from one another and extend longitudinally to establish a length of the sides of the vehicle frame 28. In an embodiment, the battery pack 18 is mounted within the space between the side rails 25. The battery pack 18 may be either directly or indirectly mounted to the side rails 25 using mechanical fasteners or any other suitable fastening technique.

Due at least in part to its underbody mounting location, the battery pack 18 may be susceptible to various vehicle loads including, but not limited to, impact loads (e.g., loads imparted during impact events and running clearance events, for example), durability loads, and inertial loads. If not isolated, these impact loads could be transferred directly into the battery pack 18, which could, in turn, generate relatively large forces that can damage the relatively sensitive internal components of the battery pack 18.

Novel energy absorbing structures for protecting the battery pack 18 from impact loads are therefore proposed in this disclosure. As discussed in greater detail below, the energy absorbing structures are capable of absorbing and mitigating impact loads that may be imparted during vehicle impact loading events (e.g., front, side, side pole, rear, etc.), thereby substantially minimizing the transfer of impact loads inside the battery pack 18.

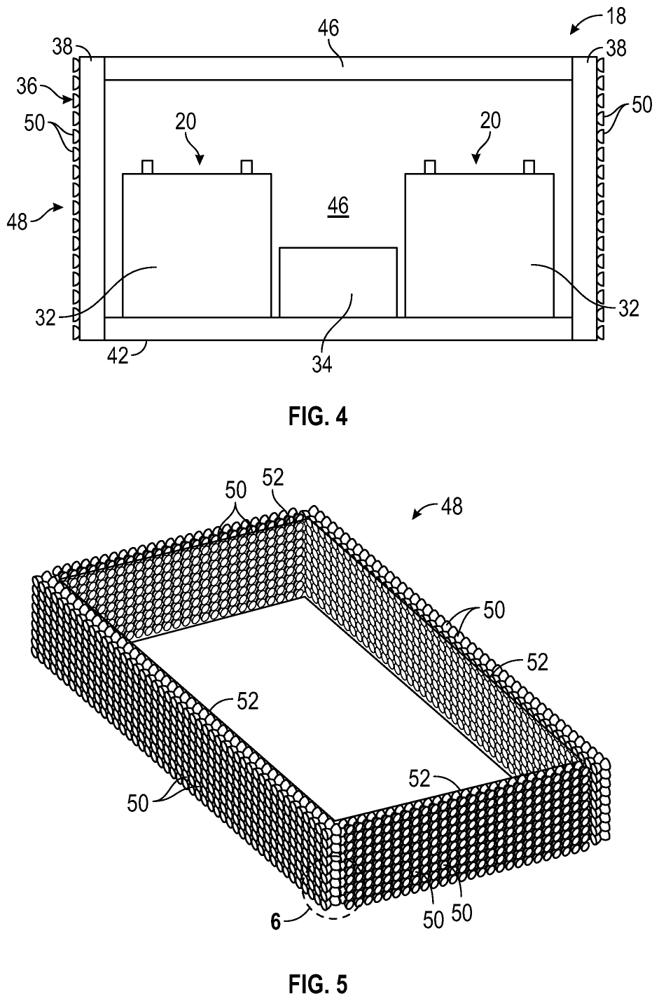

FIGS. 3-4 further illustrate the exemplary battery pack 18 of the electrified vehicle 10 of FIGS. 1-2. The battery pack 18 may house a plurality of battery cells 32 (see FIG. 4) that store energy for powering various electrical loads of the electrified vehicle 10, such as the electric machine 12 of FIG. 1, for example. In an embodiment, the battery pack 18 houses prismatic, lithium-ion battery cells. However, battery cells having other geometries (cylindrical, pouch, etc.), other chemistries (nickel-metal hydride, lead-acid, etc.), or both could alternatively be utilized within the scope of this disclosure.

The battery pack 18 may additionally house one or more battery electronic components 34 (See FIG. 4). The battery electronic component 34 could include a bussed electrical center (BEC), a battery electric control module (BECM), wiring harnesses, wiring loops, I/O connectors etc., or any combination of these battery electronic components.

The battery cells 32 may be grouped together in one or more battery arrays 20. In an embodiment, the battery pack 18 includes two battery arrays 20. However, the total numbers of battery cells 32 and battery arrays 20 employed within the battery pack 18 are not intended to limit this disclosure.

Although an example placement of the battery arrays 20 and the battery electronic components 34 is shown in FIG. 4, this particular placement is not intended to limit this disclosure. The battery arrays 20 and the battery electronic components 34 of the battery pack 18 can be arranged in any configuration within the battery pack 18.

An enclosure assembly 36 may house each battery array 20 and battery electronic component 34 of the battery pack 18. Since the battery arrays 20 and the battery electronic components 34 are housed inside the enclosure assembly 36, these components are considered battery internal components of the battery pack 18. The battery internal components are examples of the types of sensitive components that could become damaged if impact loads are transferred into the battery pack 18 during vehicle impact loading events.

In an embodiment, the enclosure assembly 36 is a sealed enclosure. The enclosure assembly 36 may include any size, shape, and configuration within the scope of this disclosure.

The enclosure assembly 36 may include a pair of side walls 38, a pair of end walls 40, and a bottom wall 42 that are arranged and connected relative to one another to establish an open area 44 for receiving the battery arrays 20 and the battery electronic components 34. The side walls 38, end walls 40, and bottom wall 42 may be connected together in any manner to form a tray of the enclosure assembly 36. After positioning the battery arrays 20 and the battery electronic components 34 within the open area 44, a top wall 46 of the enclosure assembly 36 may be seated and sealed relative to the side walls 38 and the end walls 40 to cover the battery arrays 20 and the battery electronic components 34 and enclose these battery internal components inside the battery pack 18.

The enclosure assembly 36 may additionally include an energy absorbing structure 48 that is adapted to absorb impact loads that may be imparted during vehicle impact loading events. The battery absorbing structure 48 may include a plurality of fluid filled unit cells 50. One or more of the fluid filled unit cells 50 may be attached to one or more of the side walls 38, end walls 40, bottom wall 42, and top wall 46 of the enclosure assembly 36 in order to at least partially surround the battery pack 18 to provide energy absorbing behavior in different loading directions during an impact event. In an embodiment, one or more of the fluid filled unit cells 50 is attached to both of the side walls 38 and both of the end walls 40 such that the energy absorbing structure 48 surrounds an outer side perimeter of the open area 44. In another embodiment, one or more of the fluid filled unit cells 50 is attached to each of the side walls 38, end walls 40, bottom wall 42, and top wall 46 of the enclosure assembly 36 such that all sides of the battery pack 18 are protected during impact events.

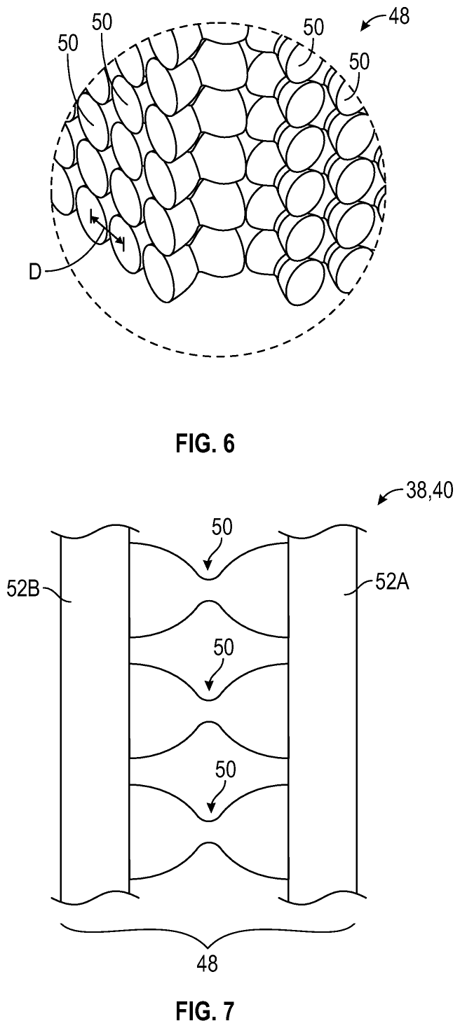

FIGS. 5-6, with continued reference to FIGS. 1-4, illustrate an exemplary energy absorbing structure 48 of the enclosure assembly 36 of the battery pack 18. Each of the side walls 38 and the end walls 40 of the enclosure assembly 36 may include a rigid plate 52. The rigid plates 52 may be constructed out of steel or some other relatively rigid material. The fluid filled unit cells 50 may be constructed out of a compressible material and are generally less rigid than the rigid plates 52. For example, the fluid filled unit cells 50 may be constructed out of polymer-based materials or compressible metallic materials, such as aluminum.

Each fluid filled unit cell 50 may be attached to one of the rigid plates 52. In an embodiment, the fluid filled unit cells 50 are arranged in an array of vertical and horizontal rows on each of the rigid plates 52. In another embodiment, each of the side walls 38 and the end walls 40 of the enclosure assembly 36 include a first rigid plate 52A and a second rigid plate 52B, and the fluid filled unit cells 50 are sandwiched between the first and second rigid plates 52A, 52B (see, e.g., FIG. 7). However, the specific arrangement and total number of fluid filled unit cells 50 provided within the energy absorbing structure 48 is not intended to limit this disclosure.

Adjacent fluid filled unit cells 50 may be spaced apart by a distance D (see FIG. 6) within each wall of the enclosure assembly 36 that includes the energy absorbing structure 48. The stiffness of the energy absorbing structure 48 can be controlled by modifying the distance D. In general, a larger distance D between adjacent fluid filled unit cells 50 produces a less stiff construct, whereas a smaller distance D between adjacent fluid filled unit cells 50 produces a stiffer construct.

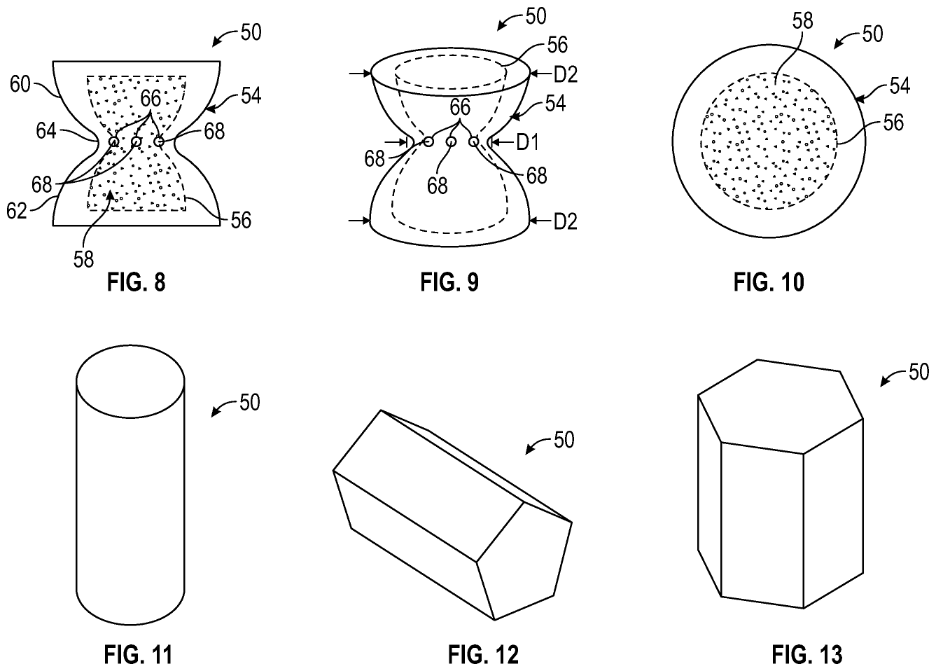

FIGS. 8, 9, and 10 illustrate an exemplary fluid filled unit cell 50 of the energy absorbing structure 48 described above. The fluid filled unit cell 50 may include an outer housing 54 and a hollow chamber 56 formed inside the outer housing 54. A fluid 58 may be contained within the hollow chamber 56. The fluid 58 may be a compressed air or a compressed liquid, such as a coolant, for example. As explained in further detail below, the fluid 58 can be leaked from the fluid filled unit cell 50 during vehicle impact events in order to modify the stiffness of the outer housing 54 and thereby absorb impact energy.

In an embodiment, the outer housing 54 of the fluid filled unit cell 50 includes an hourglass shape. However, other shapes are also contemplated within this disclosure, including but not limited to, cylindrical (see FIG. 11), pentagonal (see FIG. 12), or hexagonal (see FIG. 13) shaped.

The outer housing 54 of the fluid filled unit cell 50 may include a first section 60, second section 62, and a mid-section 64 disposed between the first section 60 and the second section 62. In an embodiment, the mid-section 64 includes a first diameter D1 that is smaller than a second diameter D2 of each of the first section 60 and the second section 62. However, other configurations are also contemplated.

The fluid filled unit cell 50 may include a plurality of vent holes 66. The vent holes 66 may be formed in the mid-section 64 or any other section of the outer housing 54. However, the location and total number of the vent holes 66 is design dependent and therefore not intended to limit this disclosure.

Each vent hole 66 may include a diameter D3. The stiffness of the fluid filled unit cell 50 can be controlled by modifying the diameter D3. In general, a larger diameter D3 will allow the fluid 58 to escape from the outer housing 54 more quickly and therefore produces a less stiff construct, whereas a smaller diameter D3 will allow the fluid 58 to escape more slowly and therefore produce a stiffer (and more energy absorbing) construct.

In an embodiment, the diameter D3 is between about 2 mm and about 6 mm (between about 0.079 and 0.236 inches). In another embodiment, the diameter D3 of the vent holes 66 is between about 10% and about 20% of the diameter D2 of the first and second sections 60, 62 of the outer housing 54. In this disclosure, the term “about” means that the expressed quantities or ranges need not be exact but may be approximated and/or larger or smaller, reflecting acceptable tolerances, conversion factors, measurement error, etc.

Each vent hole 66 may be closed by a membrane 68 in order to contain the fluid 58 within the hollow chamber 56. The membranes 68 may be made of a different material from the material of the outer housing 54. In an embodiment, the membranes 68 are made of polyvinyl chloride (PVC) or a suitable fabric material, such as a nylon fabric.

Each membrane 68 of the fluid filled unit cell 50 is configured to rupture as the pressure inside the outer housing 54 increases, such as in response to a vehicle impact event. The fluid 58 may escape through the vent holes 66 once the membranes 68 rupture. As the fluid 58 is expelled from the fluid filled unit cell 50, the stiffness of the outer housing 54 is altered and impact energy that could otherwise be imparted inside the battery pack 18 is absorbed.

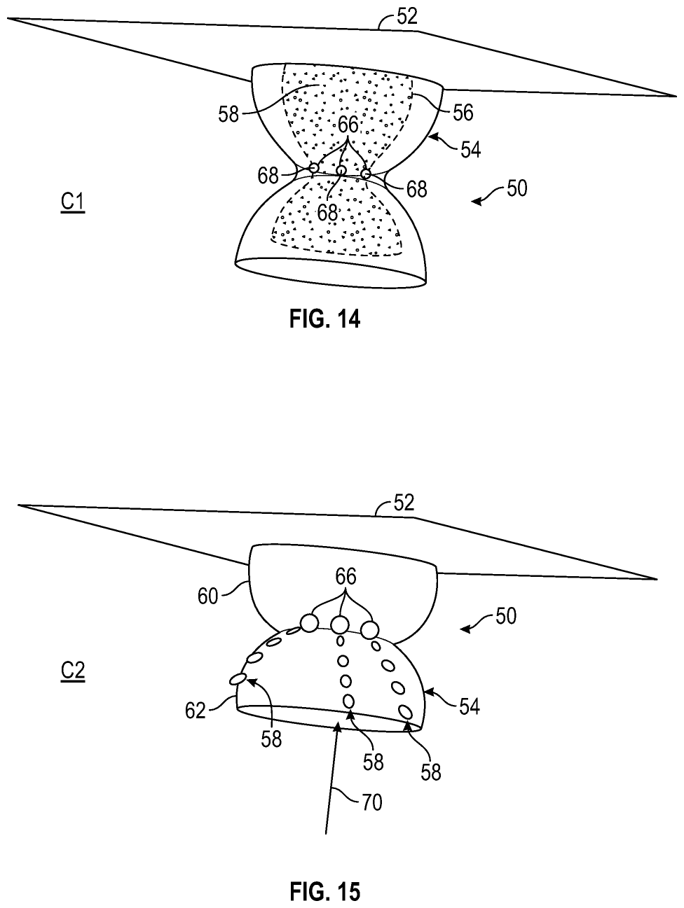

FIGS. 14-15 schematically illustrate the behavior of one of the fluid filled unit cells 50. Referring first to FIG. 14, the fluid filled unit cell 50 is shown during a non-loaded condition C1. In this condition, the membranes 68 are un-ruptured and the fluid 58 is therefore contained inside the hollow chamber 56 of the outer housing 54.

The fluid filled unit cell 50 is shown in a loaded condition C2 in FIG. 15. The loaded condition C2 may occur during a vehicle impact loading event, such as a side or side pole impact event. The impact loading event is schematically shown by the arrow 70 of FIG. 15.

The impact loading event 70 may tend to compress the outer housing 54 of the fluid filled unit cell 50 such that the first and second sections 60, 62 both widen and compress toward one another. As this compression occurs, the pressure inside the outer housing 54 increases. The pressure increase may rupture the membranes 68 and allow the fluid 58 to be expelled through the vent holes 66, thereby absorbing energy associated with the impact loading event 70. The fluid 58 that leaks from the fluid filled unit cell 50 may also have a secondary benefit of cooling any surrounding components of the battery pack 18 during and after the vehicle impact event.

The exemplary battery pack energy absorbing structures of this disclosure provide efficient strategies for load path management during vehicle impact loading events. The energy absorbing structures may provide for adaptive energy absorption through the use of fluid filled unit cells. The stiffness of the unit cells may be controlled by regulating the pressure inside the unit cells. The proposed designs provide an efficient solution for protecting electrified vehicle traction battery internal components during and after vehicle impact events.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery pack, comprising:
an enclosure assembly; and
a battery array received within the enclosure assembly,
wherein the enclosure assembly includes an energy absorbing structure comprised of a plurality of fluid filled unit cells.

2. The battery pack as recited in claim 1, wherein each of the plurality of fluid filled unit cells is made of a compressible polymer-based or metallic material.

3. The battery pack as recited in claim 1, wherein each of the plurality of fluid filled unit cells includes an outer housing that includes a hollow chamber, and a fluid is held within the hollow chamber.

4. The battery pack as recited in claim 3, wherein the fluid is a compressed air or a coolant.

5. The battery pack as recited in claim 3, comprising a vent hole formed in the outer housing and a membrane that covers the vent hole.

6. The battery pack as recited in claim 5, wherein the membrane is configured to rupture as a pressure inside the outer housing increases.

7. The battery pack as recited in claim 1, wherein at least one of the plurality of fluid filled unit cells include an hourglass shape.

8. The battery pack as recited in claim 1, wherein the plurality of fluid filled unit cells are attached to a rigid plate of a wall of the enclosure assembly.

9. The battery pack as recited in claim 1, wherein the plurality of fluid filled unit cells are sandwiched between a first rigid plate and a second rigid plate of a wall of the enclosure assembly.

10. The battery pack as recited in claim 1, wherein the plurality of fluid filled unit cells are arranged in an array of horizontal and vertical rows within a wall of the enclosure assembly.

11. The battery pack as recited in claim 1, wherein each of the plurality of fluid filled unit cells includes an outer housing, a hollow chamber that contains a fluid inside the outer housing, a vent hole formed through the outer housing, and a membrane that covers the vent hole.

12. The battery pack as recited in claim 11, wherein the membrane is configured to rupture as a pressure inside the outer housing increases, thereby allowing the fluid to escape through the vent hole to a location outside of the outer housing.

13. An electrified vehicle, comprising:
a frame; and
a traction battery pack mounted to the frame;
wherein the traction battery pack includes an energy absorbing structure that comprises a plurality of fluid filled unit cells.

14. The electrified vehicle as recited in claim 13, wherein the frame includes a first rail and a second rail that establish part of an underbody of the electrified vehicle, and the traction battery pack is mounted between the first rail and the second rail.

15. The electrified vehicle as recited in claim 13, wherein each of the plurality of fluid filled unit cells includes an outer housing, a hollow chamber within the outer housing, and a fluid contained within the hollow chamber.

16. The electrified vehicle as recited in claim 15, comprising a vent hole formed through the outer housing and a membrane that covers the vent hole to contain the fluid within the hollow chamber during a non-loaded condition of the energy absorbing structure.

17. The electrified vehicle as recited in claim 16, wherein, during a loaded condition of the energy absorbing structure, the membrane is configured to rupture and allow the fluid to leak out of the outer housing through the vent hole.

18. The electrified vehicle as recited in claim 17, wherein the fluid is a coolant.

19. The electrified vehicle as recited in claim 15, wherein the outer housing comprises a first material and the membrane comprises a second material that is different from the first material.

20. The electrified vehicle as recited in claim 19, wherein the second material is a nylon fabric.
